(19) United States
(12) Patent Application Publication
(10) Pub. No.: US 2017/0303342 A1
(43) Pub. Date: Oct. 19, 2017

(54) ELECTRIC HEATING DEVICE

(71) Applicant: Gentherm GmbH, Odelzhausen (DE)

(72) Inventors: Michael Weiss, Benediktbeuern (DE); Denise Philipp, Altomünster (DE); Martin Krobok, Aichach (DE)

(21) Appl. No.: 15/516,174

(22) PCT Filed: Oct. 16, 2015
(86) PCT No.: PCT/DE2015/000512

§ 371 Date: Mar. 31, 2017

(30) Foreign Application Priority Data
Oct. 17, 2014 (DE) 10 2014 015 320.7

(51) Int. Cl. H05B 3/34; H05B 3/03

(52) U.S. Cl. CPC H05B 3/342; H05B 3/34; H05B 3/03; H05B 2203/029

(57) ABSTRACT

The present invention relates to an electrical heating device (25), comprising at least one electric heating resistance (27) and at least one heating resistance support (26). It is provided that the heating resistance (27) is disposed as a conductor strip at the heating resistor support (26), and that the heating resistance (27) comprises a stabilizing layer (28′, 28″) in addition to the heating resistance support (26).

### BACKGROUND OF THE INVENTION

The invention relates to an electrical heating device corresponding to the preamble of claim 1, particularly a heating device for heating the interior of a motor vehicle, which device is disposed close to the surface inside the vehicle interior.

### PRIOR ART

Heating means which employ copper wires or the like are known. When used behind leather, however, these (copper wires) tend to stand out (become conspicuous). If a textile layer is inserted between the heating means and the leather, in order to prevent this phenomenon, this increases the thermal resistance to the interior surface. If the interior component is, e.g., a door or other component in the body or chassis, this means increased heating of the exterior surfaces of the vehicle rather than the surfaces of the interior vehicle compartment. This would result in substantial loss of energy.

If heating films are used instead of wires, they will form creases and/or folds during installation.

A further option is for heating means printed onto textiles. These are very sensitive, due to the weak internal cohesion of printed conductive layers, and are not well able to withstand tensile or kinking stresses.

### CLAIMED MATTER OF THE INVENTION

Over this background, a technical concept having the features of claim 1 is now proposed. Additional refinements may be denied from the other claims, and from the description hereinbelow.

The invention enables rapid and energy-saving beating of interior components, without adverse optical or haptic consequences to the interior surfaces.

Additionally, heating devices according to the present invention are quite robust in the face of mechanical stresses during assembly and in operation.

### FIGURES

In the following, features of the invention will be described. These features (and the associated embodiments) will aid in making the invention understandable. However, they are only exemplary in nature. It goes without saying that one or more of the described features may be eliminated, modified, or supplemented within the scope of the invention as set forth in the independent claims. Also, obviously features of different embodiments may be combined with each other. The critical factor is that the underlying concept of the invention be adopted. If a feature is at least partly to be realized, this implies that said feature may be completely realized or substantially completely realized. The term “substantially” here means that the implementation allows the desired benefit to be achieved to a recognizable extent. This may mean that a corresponding feature is realized to the extent of 50%, 90%, 95%, or 99%. If a minimum value is stated, it may be assumed that also more than that minimum value may be employed, if the number of instances of a given component is slated to be “at least one”, this means that, embodiments with two, three, or another number of instances of the component are possible. A description applied to a particular object may be assumed to apply to most or all other similar objects. Unless stated otherwise, intervals include their end point. The term “a” or “an” is employed below as an indefinite article, and may mean “one” or “at least one”. The accompanying drawings are as follows:

FIG. 1A illustrates a vehicle with temperature-controlled interior seating 2, in a partial longitudinal cross section;

FIG. 1B is a cross section through a heating device of an interior component of the vehicle according to FIG. 1A; and

FIG. 1C is a plan view of the heating device according to FIG. 1B.

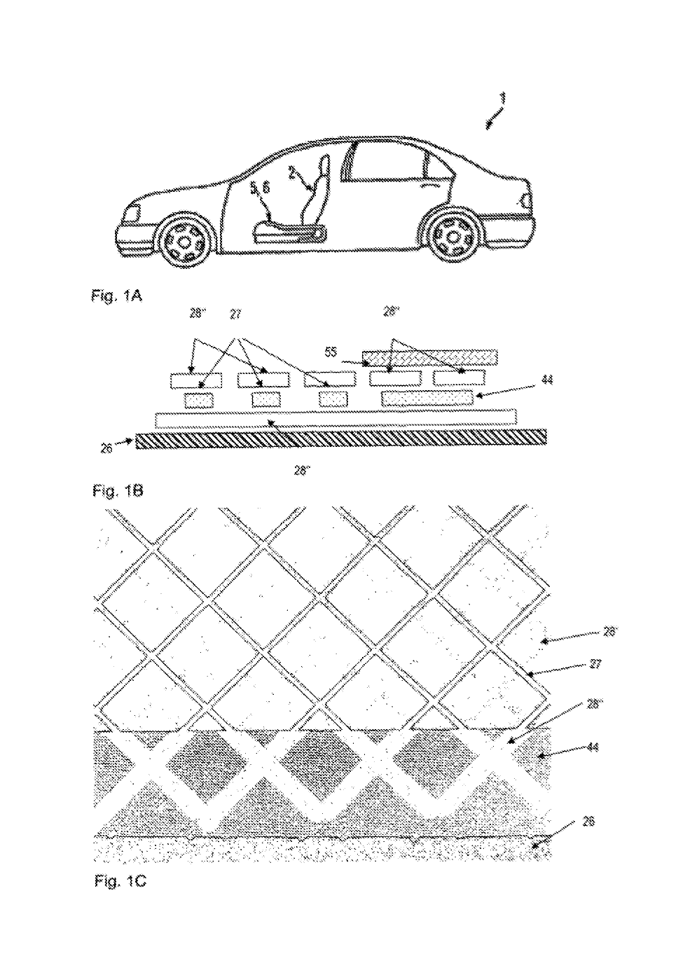

### DESCRIPTION OF THE INVENTION

The present invention relates to a vehicle 1. The term “vehicle” means in particular a device for transporting persons and/or goods. Conceivably a vehicle may comprise, e.g., a land, water, rail or air transport vehicle, particularly an aircraft, boat, or automotive motor vehicle.

The invention also relates to a climate-controlled system 2. The term “climate-controlled system” means in particular an object which is to be influenced regarding at least one climate control parameter, thus is subjected to control and/or regulation, in particular with the aim of bringing the parameter, at least for a brief period, to a specified set-point value or set-point range, and/or holding the parameter there for an extended period. This applies in particular for parts of the surface of it (the object) with which a particular medium may come into contact, or with which a user may come into contact at least potentially when using the object. The term “controlled system” means in particular an object which is subjected to control and/or regulation with regard to at least one parameter. The term “climate control parameter” means in particular at least one climatic parameter, such as temperature, air humidity, air composition, and/or fluid flow speed. Areas of application include (as here) climate-controlled seats or steering wheels, seat rests (seat bottoms), office equipment, passenger compartment panels, storage containers, fuel lines, battery housings, or motors other functional elements. It may also be provided that the “climate-controlled system” 2 comprises a zone which is to be supplied with air (ventilation), particularly in a vehicle 1. E.g., in a vehicle with an open roof, the head and shoulders region of a passenger may be supplied with a uniform air stream of desired temperature, in order to cancel out turbulence due to the vehicle wind.

Advantageously, at least one climate-controlled system 2 has at least one cushion 4. The term “cushion” means at least one device for damping of shocks and/or for distribution of local pressure peaks on a relatively large surface. An example might be blocks of polyurethane foam.

Preferably, at least one climate-controlled system 2 has at least one cover 5. The term “cover” relates in particular to a surface structure which is disposed on the surface of an object, or at least on some regions of an object. Examples of covers which might be employed are air-permeable or air-impermeable layers which are comprised of perforated or un-perforated leather and/or textiles and are disposed on a cushion; or fur materials which cover at least part of a surface of a foam-like material.

Advantageously, at least one temperature-control device 22 has at least one heating device 25. The term “heating device” relates in particular to a device which provides thermal energy for purposeful heating of its surroundings, by conductive, convective, and/or radiative means. This enables rapidly acting or long-acting heating of a user or of an object which it is desired to heat, particular the interior of a housing or compartment. Examples are devices with at least one heating resistance, a flexible textile-type surface heating element, a heat pump, a Peltier element, a radiator, a convector, and/or a heating coil.

Advantageously, at least one heating device 25 at least partially has a position which is associated with low thermal insulation against a zone to be temperature controlled. This allows low energy consumption and rapid effectiveness of the heating. For example, (low-insulation) positions directly on the underside of a cover, preferably without intermediate cushioning or trim layers, might be employed under a cover layer and below a lining on an inner side of a housing wall, as well as in channels or inserts (e.g. inner layers) which are inserted into a cushion.

It is advantageous if at least one heating device 25 has at least one heating resistance support 26. The term “heating resistance support” refers in particular to, e.g., a device for mechanical de-stressing of a heating resistance, and/or for fixing the spatial disposition of a heating resistance. Particularly suitable are flexible surface structures, preferably comprised at least partly of textiles, knitted materials, interlinked materials, woven materials, non-woven fabrics, flexible thermoplastics, punched or nabbed or knobbed films, air-permeable materials, or the control system itself. Preferably the heating resistance support 26 is completely or partially fabricated from a textile. At least a part, of the textile and/or its threads is preferably comprised of polyester. Preferably, the textile and/or its threads has a thickness of less than 1 mm, preferably less than 0.5 mm, particularly preferably less than 0.2 mm. Preferably, a woven fabric is used.

The term “textile” is understood to refer in particular to the following arrangements:

(a) a first group of a plurality of threads is arranged in a first direction of extent, substantially parallel to one another in the plane of the textile;

(b) a second group of a plurality of threads is arranged in a second direction of extent, substantially parallel to one another;

(e) the direction of extent of the first group crosses the direction of the second group within the plane of the textile; and/or

(d) one or more threads of the first group extend alternately underneath and then over one or more threads of the second group.

Advantageously, at least one heating device 25 has at least one heating resistance 27. The term “heating resistance” means in particular an electrical resistance which gives off thermal energy when an electric current passes through it, which energy directly or indirectly serves to heat a climate-controlled system 2. A heating resistance is preferably in the form of a flat, conductive conductor strip, it is preferably fabricated from an ink or paste which is printed onto a heating resistance support 26.

Advantageously, at least one heating device 25 has at least one stabilizing layer 28. The term “stabilizing layer” means in particular a layer which is provided in addition to the heating resistance support 26. It serves to stabilize the heating resistance 26, particularly against tearing and breakage. Preferably it is fabricated from a flexible paint-like coating, a printed paste material, and/or a printed ink material. It is preferably applied by printing or spray-coating. Preferably, a plurality of stabilizing layers 28 or stabilizing layer sections are provided.

Preferably, a first stabilizing layer 28′ is applied directly to the heating resistance support 26, in order to smooth out the unevennesses in the latter, and to prevent fibers or threads of the heating resistance support from absorbing the material of the heating resistances 27. This layer 28′ is applied preferably essentially over the entire area. The first stabilizing layer 28′ thus also functions as a smoothing and separating layer. At least one heating resistance 27 is spaced apart from the heating resistor support 26 by a stabilizing layer 28′.

Preferably, at least one second stabilizing layer 28″ is printed onto at least one beating resistance 27 and/or onto an electrode 44 contacting this heating resistance 27. It serves to protect these two components from corrosion. The application of the second stabilizing layers) is preferably not carted out over the entire area but only directly on or in adjacent areas of electrically conductive layers. At least one heating resistance 27 is preferably completely covered. Larger electrically conductive layers such as the electrode 44 are preferably only partially covered by the second stabilizing layer(s) 28″ when additional electrical conductors 55 are disposed on such larger layers. As a result, the second stabilizing layer 28″, similarly to the first stabilizing layer 28′, can provide kinking protection and stress relief without interfering with any electrically necessary current flows.

Advantageously, at least one heating device 25 has at least one electrode 44 for contacting one or more heating resistances 27. The term “electrode” in particular means an electrical conductor which serves to supply a heating resistance 27 with electricity. For this purpose, the absolute electrical conductivity of the electrode is at least twice that of a heating resistance 27. At least one electrode is preferably provided as a flat, conductive strip 37. It is preferably fabricated from a printed ink or printed paste, which is printed on the heating resistance support 26. It is preferably comprised of the same material and has the same material thickness as at least one heating conductor 37. The greater conductivity preferably derives from the greater width of the conductive strips.

Preferably, at least one supplemental electrical conductor 55 is disposed at an electrode 44, in order to increase the stability and current-carrying capacity of the electrode. In addition, such an additional conductor 55 can be thicker than the electrode 44. It is therefore advantageous for the additional conductor 55 to be connected to a current source via a supply line, so that a heating current can flow into the heating device 25 via at least one electrode 44 associated with at least one additional conductor 55. Preferably, this (the additional conductor) is a copper strip. In order to ensure sufficient electrical contact between the additional conductor 55 and the electrode 44, stabilizing layers 28 between the two components should not cover the entire electrode. Thus, openings are provided in or between two stabilizing layers 28″, through which openings the electrode 44 is exposed to the additional conductor 55. The stabilizing layer is also preferably thinner than 1 mm, preferably thinner than 0.5 mm. This allows mechanical and electrical contact to actually take place, and avoids folding of any of the participating components.

Preferably, in the region of at least one electrode 44, the heating device 25 has the following layer structure: heating resistance support 26, first stabilizing layer 28′, electrode 44, second stabilizing layer 28″ with openings, and copper contact strip. Preferably, the heating device 25 has the following structure in the region of at least one region to be heated: heating resistance support 26, first stabilizing layer 28′, and heating resistance 27. Both regions can additionally be covered by a further protective layer, e.g. a paint-type coating or a further stabilizing layer.

Preferably, at least one heating resistance 27 runs differently from the first and the second flow direction of the first and second thread groups of the fabric of the heating resistance support 26. Preferably, at least one heating resistance 27 extends diagonally to these flow directions, i.e. diagonally to the weaving direction and to the wrapping direction of the fabric, in order to avoid establishing a preferred direction for the current flow, and in order to increase the mechanical stability of the heating resistance 27.

It is particularly advantageous if a coating layer is applied directly above and/or below the healing resistance. In addition, a textile support may be coated, with, e.g., a spray coating. The coating layer also protects a printed-on heating resistance against mechanical strain. A coating layer may comprise one of the stabilizing layers. It may also be provided (alternatively) as a supplemental element.

It is particularly advantageous if at least one stabilizing layer has a color, preferably a color different from that of a heating resistance support, a heating resistance, another stabilizing layer, and/or an electrode.

It is particularly advantageous if at least one heating .resistance has a color, preferably a color different, from that of a heating resistance support, one or more of the stabilizing layers, and/or an electrode.

1: An electrical heating device comprising:
at least one electrical heating resistance and
at least one heating resistance support;
wherein
the heating resistance, in the form of a conducting strip, is disposed on the heating resistance support; and
the heating resistance has a stabilizing layer, in addition to the heating resistance support.

2: An interior component comprised of at least one heating device according to claim 1.

3: A vehicle comprised of at least one heating device according to claim 1.

4: The electrical heating device of claim 1, wherein the electrical heating device includes at least one electrode on the stabilizing layer and the at least one electrode is partially covered by a second stabilizing layer.

5: The electrical heating device of claim 4, wherein the electrical heating device includes at least one supplemental electrical conductor is disposed at one of the at least one electrode.

6: The electrical heating device of claim 1, wherein the stabilizing layer is thinner than 1 mm.
